(19) United States
(12) Patent Application Publication
(10) Pub. No.: US 2021/0180518 A1
(43) Pub. Date: Jun. 17, 2021

(54) Gas Turbine Combustor

(71) Applicant: Mitsubishi Power, Ltd., Yokohama-shi (JP)

(72) Inventors: Tomomi KOGANEZAWA, Yokohama (JP); Shota IGARASHI, Yokohama (JP); Hiroaki NAGAHASHI, Yokohama (JP); Yoshitaka TERADA, Yokohama (JP)

(21) Appl. No.: 17/112,447

(22) Filed: Dec. 4, 2020

(30) Foreign Application Priority Data
Dec. 16, 2019 (JP) 2019-226377

(51) Int. Cl. F02C 7/22; F23R 3/28

(52) U.S. Cl. CPC F02C 7/222; F23R 3/28; F05D 2260/60; F05D 2240/35; F05D 2220/32

(57) ABSTRACT

A deviation of fuel injection amounts among a plurality of fuel nozzles connected to one fuel header is suppressed while suppressing increases in a manufacturing man-hour count and a pressure loss of a fuel. A gas turbine combustor includes: a liner forming a combustion chamber; a plurality of fuel nozzles; a fuel header to which the plurality of fuel nozzles are connected; and a fuel supply flow passage connected to the fuel header, the fuel header including a first chamber to which the fuel supply flow passage is connected and a second chamber to which the plurality of fuel nozzles are connected. An outlet of the fuel supply flow passage is opened in the first chamber, and at least one communication opening communicating with the first chamber is opened in the second chamber. The outlet of the fuel supply flow passage faces an inner wall surface of the first chamber. The second chamber includes a region spreading from the communication opening toward the combustion chamber, and inlets of the fuel nozzles are disposed closer to the combustion chamber than entirety of the communication opening.

### BACKGROUND OF THE INVENTION

### 1. Field of the Invention

The present invention relates to a gas turbine combustor (hereinafter, to be abbreviated as a “combustor”) and particularly relates to a combustor that distributes a fuel from one fuel header to a plurality of fuel nozzles.

### 2. Description of the Related Art

In a case of using a low nitrogen content fuel (natural gas, kerosene, light oil, or the like), most of NOx formed in a combustor is thermal NOx formed by oxidation of nitrogen in the air. Since thermal NOx formation highly depends on a temperature, a gas turbine using the low nitrogen content fuel normally seeks a NOx emissions reduction by controlling a flame temperature.

As measures for lowering the flame temperature, there is known premixed combustion for mixing a fuel with the air in advance and then burning a mixture. With the conventional premixed combustion, however, a phenomenon (flashback) of burning the fuel within a premixer possibly occurs in a case in which a temperature of the combustion air is high, a case in which a self-ignition temperature of the fuel is low, and the like.

To address the problem, a lean combustion approach to achieve a NOx emissions reduction by appropriately controlling a flame temperature while preventing a flashback is known (refer to, for example, JP-2018-128215-A). A combustor of this approach is configured with, for example, an air hole plate that has a plurality of small-diameter air holes; and a plurality of small-diameter fuel nozzles, injects a fuel from each fuel nozzle toward the corresponding air hole, and supplies many coaxial jets formed from a fuel stream and an air stream surrounding the fuel stream to a combustion chamber.

Patent Document 1: JP-2018-128215-A

In the case of achieving the NOx emissions reduction by supplying many coaxial jets to the combustion chamber, it is important to suppress unevenness of ratios of the fuel to the air (fuel-air ratio) among the coaxial jets. To suppress the unevenness, it is necessary to suppress deviations of air flow rates and fuel flow rates among the coaxial jets.

Causes for the unevenness of fuel flow rates of the coaxial jets include generation of distributions of fuel static pressures and fuel dynamic pressures of inlets among the fuel nozzles due to position relationships between a fuel inflow position relative to the fuel header (connection position of a fuel supply pipe) and inlets of the individual fuel nozzles. In other words, a fuel supply pipe is normally connected to only one portion of the fuel header, while many fuel nozzles are connected to the fuel header. A large area is necessary on a combustion chamber-side inner wall surface of the fuel header to attach the many fuel nozzles. Owing to this, the fuel nozzles differ in a distance to the fuel supply pipe, it is easier for the fuel to flow in the fuel nozzle that faces any of the fuel jets jetted from the fuel supply pipe to the fuel header, and it is more difficult for the fuel to flow in the fuel nozzle that has a large axial misalignment amount with respect to the fuel jets. While there is known a method of suppressing a deviation of fuel flow rates among the fuel nozzles by providing orifices on the fuel nozzles, installing the orifices on the many fuel nozzles disadvantageously causes increases in a man-hour count and a cost and also an increase in a pressure loss of the fuel.

### SUMMARY OF THE INVENTION

An object of the present invention is to provide a gas turbine combustor capable of suppressing a deviation of fuel injection amounts among a plurality of fuel nozzles connected to one fuel header and suppressing increases in a manufacturing man-hour count and in a pressure loss of a fuel.

To attain the object, the present invention provides a gas turbine combustor including: a cylindrical liner that forms a combustion chamber inside of the cylindrical liner; a plurality of fuel nozzles each disposed with an injection hole oriented toward the combustion chamber; a fuel header to which the plurality of fuel nozzles are connected; and a fuel supply flow passage connected to the fuel header. The fuel header includes a first chamber to which the fuel supply flow passage is connected, and a second chamber to which the plurality of fuel nozzles are connected. Further, an outlet of the fuel supply flow passage is opened in the first chamber, at least one communication opening communicating with the first chamber is opened in the second chamber, and the outlet of the fuel supply flow passage faces an inner wall surface of the first chamber. Furthermore, the second chamber includes a region spreading from the communication opening toward the combustion chamber, and inlets of the plurality of fuel nozzles are located closer to the combustion chamber than entirety of the communication opening.

According to the present invention, it is possible to suppress the deviation of fuel injection amounts among the plurality of fuel nozzles connected to one fuel header and suppress increases in the manufacturing man-hour count and in the pressure loss of the fuel.

### BRIEF DESCRIPTION OF THE DRAWINGS

FIG. 1 is a schematic diagram of a gas turbine plant according to a first embodiment of the present invention;

FIG. 2 is an enlarged cross-sectional view representing a position relationship between a fuel nozzle and an air hole in a gas turbine combustor according to the first embodiment of the present invention;

FIG. 3 depicts an air hole plate viewed from a combustion chamber side and provided in the gas turbine combustor according to the first embodiment;

FIG. 4 is a perspective cross-sectional view taken along a line IV-IV of FIG. 3;

FIG. 5 is a perspective cross-sectional view of an end cover taken along a line V-V of FIG. 1;

FIG. 6 is a partial cross-sectional view of enlarged configurations of a fuel header provided in the gas turbine combustor according to the first embodiment of the present invention;

FIG. 7 is a cross-sectional view of a gas turbine combustor according to a second embodiment of the present invention;

FIG. 8 depicts an air hole plate viewed from the combustion chamber side and provided in the gas turbine combustor according to the second embodiment of the present invention;

FIG. 9 is a partial cross-sectional view of enlarged configurations of a fuel header provided in the gas turbine combustor according to the second embodiment of the present invention;

FIG. 10 is a perspective cross-sectional view of an end cover taken along a line X-X of FIG. 7;

FIG. 11 is a cross-sectional view of a gas turbine combustor according to a third embodiment of the present invention;

FIG. 12 is a perspective cross-sectional view of an end cover taken along a line XII-XII of FIG. 11;

FIG. 13 depicts an air hole plate viewed from the combustion chamber side and provided in the gas turbine combustor according to the third embodiment of the present invention; and

FIG. 14 is a cross-sectional view of a gas turbine combustor according to a fourth embodiment of the present invention.

### DESCRIPTION OF THE PREFERRED EMBODIMENTS

Embodiments of the present invention will be described hereinafter with reference to the drawings.

### First Embodiment

### Gas Turbine

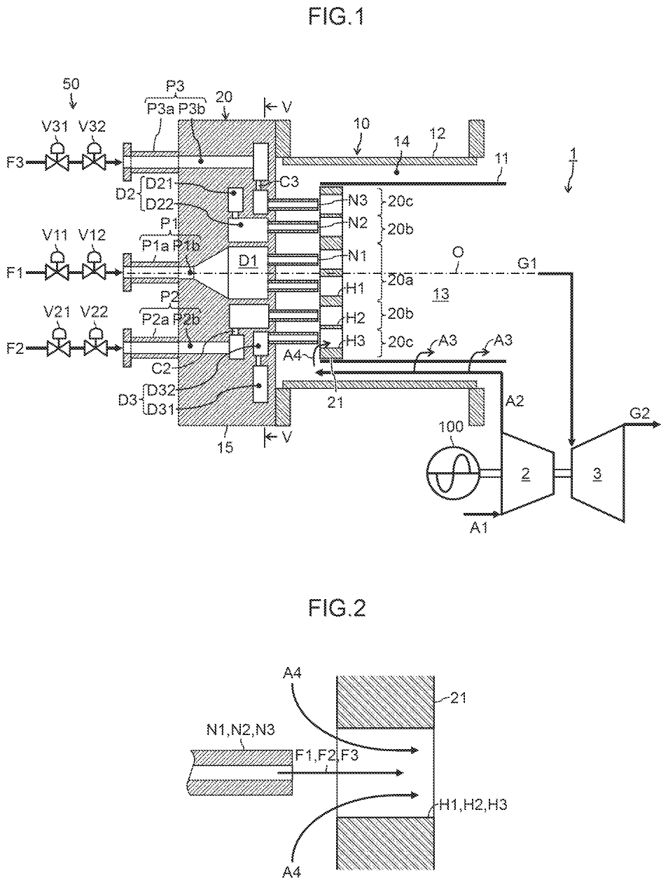

FIG. 1 is a schematic diagram of a gas turbine plant according to a first embodiment of the present invention. In FIG. 1, a combustor 10 (to be described later) is illustrated by a cross-sectional view including a central axis O of a liner 11 (to be described later). It is noted that in a case of simply referring to “upstream” or “downstream” in the present specification, this means “upstream” or “downstream” with reference to a fuel injection direction (right direction in FIG. 1) of fuel nozzles N1 to N3 (to be described later). In other words, in a case of, for example, a “region upstream of the liner 11,” this means a region leftward of the liner 11 in FIG. 1.

The gas turbine plant depicted in FIG. 1 is configured with an electric generator 100 and a gas turbine 1 that serves as a prime mover driving this electric generator 100. The gas turbine 1 is configured with a compressor 2, the gas turbine combustor (hereinafter, to be abbreviated as a “combustor”) 10, and a turbine 3. The compressor 2 draws in and compresses air (atmosphere) A1 and generates high-pressure compressed air A2. The combustor 10 mixes up combustion air guided from the compressor 2 with fuels (gaseous fuels) F1 to F3, burns mixtures, and generates a combustion gas G1. The turbine 3 is driven by the combustion gas G1 generated by the combustor 10. The combustion gas G1 that has driven the turbine 3 is emitted as exhaust gas G2. In the present embodiment, rotors (not depicted) of the compressor 2 and the turbine 3 are coupled to each other, the compressor 2 is driven by rotational power of the turbine 3, and the electric generator 100 coupled to the compressor 2 is driven to generate electricity. It is noted that the gas turbine 1 is driven by a startup motor (not depicted) only at a time of start of startup.

### Combustor

The combustor 10 is a so-called lean combustion type combustor and attached to a turbine casing (not depicted) of the gas turbine 1. This combustor 10 is configured with the liner (combustion liner) 11, a flow sleeve (combustor outer casing) 12, a burner 20, and a fuel supply system 50.

### Liner

The liner 11 is a member that is formed into a cylindrical shape and that forms a combustion chamber 13 thereinside, and is disposed downstream of an air hole plate (to be described later). An upstream end portion of the liner 11 surrounds an outer circumference of the air hole plate 21.

### Flow Sleeve

The flow sleeve 12 is a cylindrical member having a larger inside diameter than that of the liner 11 and surrounding an outer circumference of the liner 11, and forms a cylindrical air flow passage 14 between the flow sleeve 12 and the liner 11. The air hole plate 21 and fuel nozzles N1 to N3 are disposed inside of the flow sleeve 12. An end portion of the flow sleeve 12 opposite to the turbine 3 (left side in FIG. 1) is closed by an end cover (combustor cover) 15.

The compressed air A2 from the air compressor 2 circulates in the air flow passage 14 formed by the flow sleeve 12 around the liner 11 in a direction away from the turbine 3, and an outer circumferential surface of the liner 11 is subjected to convection cooling by the compressed air A2 flowing in the air flow passage 14. In addition, many holes are formed in a wall surface of the liner 11, part of the compressed air A2 flowing in the air flow passage 14 flows into the combustion chamber 13 through those holes as cooling air A3, and an inner circumferential surface of the liner 12 is subjected to film cooling by the cooling air A3. Furthermore, the compressed air A2 passing through the air flow passage 14 is supplied to the burner 20 as the combustion air A4 and jetted, together with the gaseous fuels F1 to F3 supplied from the fuel supply system 50 to the burner 20, from air holes H1 to H3 of the air hole plate 21 to the combustion chamber 13. Air-fuel mixed gases of the fuels F1 to F3 and the combustion air A4 jetted from the air holes H1 to H3 of the air hole plate 21 are burned in the combustion chamber 13 to generate the combustion gas G1, and the combustion gas G1 is supplied to the turbine 3 via a transition piece (not depicted).

### Burner

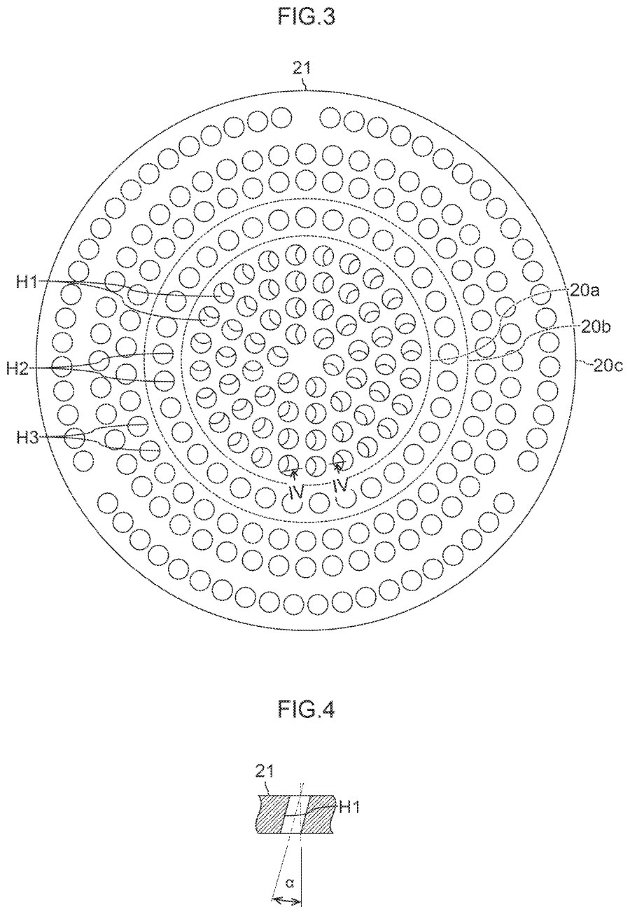

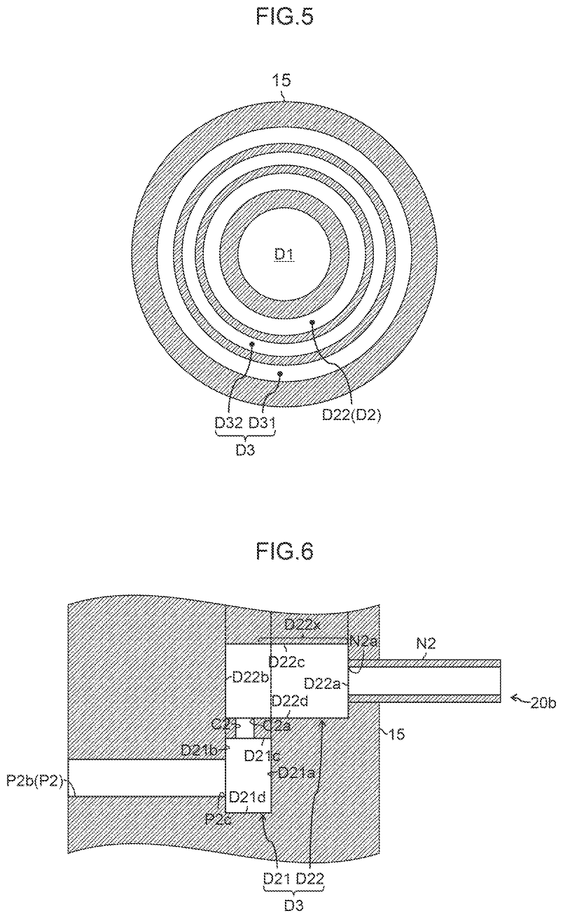

FIG. 2 is an enlarged cross-sectional view representing a position relationship between a fuel nozzle and an air hole in the combustor according to the present embodiment, FIG. 3 depicts an air hole plate viewed from a combustion chamber side, and FIG. 4 is a perspective cross-sectional view taken along a line IV-IV of FIG. 3. FIG. 5 is a perspective cross-sectional view of an end cover taken along a line V-V of FIG. 1, and FIG. 6 is a partial cross-sectional view of enlarged configurations of a fuel header D2 (to be described later). FIG. 6 does not depict a fuel header D3 to be described later.

As depicted in FIGS. 1 to 6, the burner 20 is disposed upstream of the liner 11 and includes the air hole plate 21, the fuel nozzles N1 to N3, and fuel headers (fuel distributors) D1 to D3.

The air hole plate 21 is a disc-like plate concentric with the liner 11, is disposed in the upstream end portion (one axial side) of the liner 11, and faces the combustion chamber 13. A plurality of each of the air holes H1 to H3 for supplying the combustion air A4 to the combustion chamber 13 are provided to penetrate through this air hole plate 21. In the present embodiment, the air holes H1 to H3 configure concentric air hole rows around the central axis O of the liner 11. The air holes H1 form at least one annular air hole row (four rows in the present embodiment) in a central portion of the air hole plate 21 (FIG. 3). The air holes H1 configure a circular F1 burner 20a that jets an air-fuel mixed gas of the fuel F1 and the combustion air A4. The air holes H2 form at least one annular air hole row (one row in the present embodiment) surrounding the F1 burner 20a (FIG. 3). The air holes H2 configure an annular F2 burner 20b that jets an air-fuel mixed gas of the fuel F2 and the combustion air A4. The air holes H3 form at least one air hole row (three rows in the present embodiment) surrounding the F2 burner 20b (FIG. 3). The air holes H3 configure an annular F3 burner 20c that jets an air-fuel mixed gas of the fuel F3 and the combustion air A4.

In the present embodiment, it is noted that each of the air holes H1 belonging to the central F1 burner 20a has a rotation angle a (FIG. 4), each air hole H1 is inclined in a pitch circle tangential direction, and an outlet of each air hole H1 is misaligned to one circumferential side with respect to an inlet thereof. The air-fuel mixed gas of the fuel F1 and the combustion air A4 is thereby turned as a whole, and a circulating flow generated by this rotation stabilizes a flame. Furthermore, a heat of combustion of the stable flame formed by the F1 burner 20a stabilizes flames formed by the F2 burner 20b and the F3 burner 20c. While each of the air holes H2 and H3 belonging to the F2 burner 20b or the F3 burner 20c may have a rotation angle, the air holes H2 and H3 are set parallel to the central axis O in the present embodiment.

The fuel nozzles N1 to N3 are supported by the end cover 15 in the present embodiment, and disposed upstream of the air hole plate 21, that is, disposed opposite to the combustion chamber 13 across the air hole plate 21. The fuel nozzles N1 to N3 correspond to the air holes H1 to H3 in numbers and positions (one fuel nozzle corresponds to one air hole) in a view from the combustion chamber 13 side, and configure, together with the air holes H1 to H3, the plurality of concentric annular rows around the central axis O of the liner 11. Specifically, the fuel nozzles N1 form at least one annular nozzle row (three rows in the present embodiment) so as to correspond to the air holes H1, and configure, together with the air holes H1, the F1 burner 20a described above. The fuel nozzles N2 form at least one annular nozzle rows (one row in the present embodiment) surrounding the F1 burner 20a so as to correspond to the air holes H2, and configure, together with the air holes H2, the F2 burner 20b described above. The fuel nozzles N3 form at least one annular nozzle row (three rows in the present embodiment) surrounding the F2 burner 20b so as to correspond to the air holes H3, and configure, together with the air holes H3, the F3 burner 20c described above. The fuel nozzles N1 to N3 are installed each with an injection hole oriented toward an inlet of the corresponding air hole. While each fuel nozzle N1 is disposed with the injection hole oriented toward the corresponding air hole H1, each fuel nozzle N1 may be configured in such a manner that a tip end of the fuel nozzle N1 is inserted into the corresponding air hole H1 (the injection hole of the fuel nozzle N1 is disposed within the air hole H1). The same thing is true for the fuel nozzles N2 and N3.

Each of the fuel nozzles N1 to N3 is attached to the end cover 15 in a posture in which the injection hole is oriented toward the combustion chamber 13 across the air hole plate 21, and jets the fuel F1, F2, or F3 to the combustion chamber 13 via the corresponding air hole. The fuels jetted from the fuel nozzles N1 to N3 are thereby covered with the combustion air A4 jetted from the air holes to the combustion chamber 13 at the time of passing through the corresponding air holes, and the air-fuel mixed gases of the fuels and the combustion air A4 are jetted to the combustion chamber 13 (FIG. 2). Since the fuels passing through the air holes are not mixed with the combustion air A4 yet, it is possible to prevent fuel self-ignition upstream of the air hole plate 21 and ensure high reliability of the combustor 10. Furthermore, supplying the air-fuel mixed gases to the combustion chamber 13 using the many dispersed air holes makes it possible to increase interfaces between the fuels and the air, accelerate mixtures of the fuels and the air, and suppress an amount of formation of NOx. The lean combustion type combustor 10 according to the present embodiment can thereby achieve both a NOx emissions reduction and stable combustion.

Each of the fuel headers D1 to D3 is a columnar or annular space formed inside of the end cover 15, distributes and supplies the fuel to a plurality of corresponding fuel nozzles. The fuel header D1 belongs to the F1 burner 20a, the fuel header D2 belongs to the F2 burner 20b, and the fuel header D3 belongs to the F3 burner 20c.

The fuel header D1 is the columnar space located on the central axis O, and a plurality of fuel nozzles N1 are all connected to this fuel header D1. One fuel supply flow passage P1 is connected to the fuel header D1. The fuel supply flow passage P1 is a long and thin flow passage that is formed from a flange pipe P1a and a communication flow passage P1b and that has a circular cross-section, and extends onto the central axis O. The flange pipe P1a is a cylindrical member having a flange provided in an end portion, and protrudes upstream from the end cover 15. The communication flow passage P1b is formed inside of the end cover 15, and connects a hollow flow passage of the flange pipe P1a to the fuel header D1. In the present embodiment, a downstream part of the communication flow passage P1b has a conical shape, has a flow passage cross-sectional area that becomes larger as being closer to the fuel header D1, and has an outlet diameter coincident with an inside diameter of the fuel header D1. When the fuel F1 is supplied from the fuel supply flow passage P1 to the fuel header D1, the fuel F1 with which the fuel header D1 is filled is distributed to the fuel nozzles N1 and jetted from the fuel nozzles N1.

The fuel header D2 is an annular space formed to surround an outer circumference of the fuel header D1, and a plurality of fuel nozzles N2 are all connected to this fuel header D2. One fuel supply flow passage P2 is connected to the fuel header D2. The fuel supply flow passage P2 is a long and thin flow passage (drilled hole) that is formed from a flange pipe P2a and a communication flow passage P2b and that has a circular cross-section, and extends in parallel to the central axis O at a position offset from the central axis O to an outer circumferential side of the end cover 15. The flange pipe P2a is a cylindrical member having a flange provided in an end portion, and protrudes upstream from the end cover 15. The communication flow passage P2b is formed inside of the end cover 15, and connects a hollow flow passage of the flange pipe P2a to the fuel header D2. Unlike the communication flow passage P1b of the fuel supply flow passage P1, the communication flow passage P2b of the fuel supply flow passage P2 has a uniform flow passage cross-sectional area over an entire length and is connected to one portion out of an overall circumference of the ring-shaped fuel header D2. When the fuel F2 is supplied from the fuel supply flow passage P2 to the fuel header D2, the fuel F2 with which the fuel header D2 is filled is distributed to the fuel nozzles N2 and jetted from the fuel nozzles N2.

The fuel header D3 is an annular space formed to further surround an outer circumference of the fuel header D2, and a plurality of fuel nozzles N3 are all connected to this fuel header D3. One fuel supply flow passage P3 is connected to the fuel header D3. The fuel supply flow passage P3 is a long and thin flow passage (drilled hole) that is formed from a flange pipe P3a and a communication flow passage P3b and that has a circular cross-section, and extends in parallel to the central axis O at a position further offset from the central axis O to the outer circumferential side of the end cover 15, compared with the fuel supply flow passage P2. The flange pipe P3a is a cylindrical member having a flange provided in an end portion, and protrudes upstream from the end cover 15. The communication flow passage P3b is formed inside of the end cover 15, and connects a hollow flow passage of the flange pipe P3a to the fuel header D3. Similarly to the communication flow passage P2b of the fuel supply flow passage P2, the communication flow passage P3b of the fuel supply flow passage P3 has a uniform flow passage cross-sectional area over an entire length and is connected to one portion out of an overall circumference of the ring-shaped fuel header D3. When the fuel F3 is supplied from the fuel supply flow passage P3 to the fuel header D3, the fuel F3 with which the fuel header D3 is filled is distributed to the fuel nozzles N3 and jetted from the fuel nozzles N3.

Detailed configurations of the fuel headers D2 and D3 will be described later.

### Fuel Supply System

The fuel supply system 50 is configured with an F1 fuel supply system, an F2 fuel supply system, and an F3 fuel supply system. A main flow pipe (not depicted) extending from a fuel supply source (not depicted) branches off into three pipes, and these branch pipes configure pipes of the F1 fuel supply system, the F2 fuel supply system, and the F3 fuel supply system, respectively. The pipe of the F1 fuel supply system is connected to the flange pipe P1a of the fuel supply flow passage P1, the pipe of the F2 fuel supply system is connected to the flange pipe P2a of the fuel supply flow passage P2, and the pipe of the F3 fuel supply system is connected to the flange pipe P3a of the fuel supply flow passage P3. A shut-off valve V11 and a fuel control valve V12 are provided in the pipe of the F1 fuel supply system. Likewise, a shut-off valve V21 and fuel control valve V22 are provided in the pipe of the F2 fuel supply system, and a shut-off valve V31 and a fuel control valve V32 are provided in the pipe of the F3 fuel supply system. Supply of the fuels to the F1 fuel supply system, the F2 fuel supply system, and the F3 fuel supply system can be shut off by the shut-off valves V11, V21, and V31, individually. Flow rates of the fuels flowing in the pipes of the F1 fuel supply system, the F2 fuel supply system, and the F3 fuel supply system can be regulated by the fuel control valves V12, V22, and V32, individually. In this way, the F1 burner 20a, the F2 burner 20b, and the F3 burner 20c can individually jet the fuels or stop jetting the fuels, and also individually regulate the fuel injection flow rates of the F1 burner 20a, the F2 burner 20b, and the F3 burner 20c.

It is noted that the fuels F1 to F3 supplied from the fuel supply source (not depicted) are, for example, gaseous fuels, and not only a natural gas that is a standard gas turbine fuel but also a gas containing hydrogen or carbon monoxide such as a petroleum gas, a coke oven gas, an oil refinery off-gas, and a coal gas can be used as the fuels F1 to F3.

### Fuel Header D2

As depicted in FIG. 6 as an enlarged view, the fuel header D2 described above is configured with two hollow spaces, that is, a first chamber D21 and a second chamber D22, and a communication flow passage C2 communicating the first chamber D21 with the second chamber D22.

### First Chamber D21

The first chamber D21 is formed into a ring shape, and disposed to surround an outer side of the second chamber D22 in a liner radial direction. This first chamber D21 is defined by a downstream wall surface (first downstream wall surface) D21a, an upstream wall surface (first upstream wall surface) D21b, an inner circumferential wall surface (first inner circumferential side wall surface) D21c, and an outer circumferential wall surface (first outer circumferential side) 21d. The downstream wall surface D21a is a wall surface facing an opposite side to the combustion chamber 13 (FIG. 1) (that is, closer to the combustion chamber 13), and formed into a ring shape around the central axis O. The upstream wall surface D21b is a wall surface facing the downstream wall surface D21a (that is, farther from the combustion chamber 13), and formed into a ring shape around the central axis O so as to correspond to the downstream wall surface D21a. The inner circumferential wall surface D21c is a wall surface closer to the central axis O in the first chamber D21, extends cylindrically along the central axis O, and connects inner circumferences of the downstream wall surface D21a and the upstream wall surface D21b to each other. The outer circumferential wall surface D21d is a wall surface facing the inner circumferential wall surface D21c (that is, farther from the central axis O in the first chamber D21), extends cylindrically along the central axis O, and connects outer circumferences of the downstream wall surface D21a and the upstream wall surface D21b to each other.

The fuel supply flow passage P2 (communication flow passage P2b) is connected to the first chamber D21. The outlet P2c of the fuel supply flow passage P2 is opened in the upstream wall surface D21b of the first chamber D21. The outlet P2c of the fuel supply flow passage P2 faces an inner wall surface (downstream wall surface D21a in the present example) of the first chamber D21, and is misaligned with respect to inlets N2a of all of the plurality of fuel nozzles N2 opened in the second chamber D22 in the liner radial direction (to an outer circumferential side in the present example) as described later.

### Second Chamber D22

The second chamber D22 is formed into a ring shape having a smaller diameter than that of the first chamber D21 and disposed on an inner circumferential side of the first chamber D21. This second chamber D22 is defined by a downstream wall surface (second downstream wall surface) D22a, an upstream wall surface (second upstream wall surface) D22b, an inner circumferential wall surface (second inner circumferential side wall surface) D22c, and an outer circumferential wall surface (second outer circumferential side) 22d. The downstream wall surface D22a is a wall surface facing the opposite side to the combustion chamber 13 (FIG. 1) (that is, closer to the combustion chamber 13), and formed into a ring shape around the central axis O. The upstream wall surface D22b is a wall surface facing the downstream wall surface D22a (that is, farther from the combustion chamber 13), and formed into a ring shape around the central axis O so as to correspond to the downstream wall surface D22a. The inner circumferential wall surface D22c is a wall surface closer to the central axis O in the second chamber D22, extends cylindrically along the central axis O, and connects inner circumferences of the downstream wall surface D22a and the upstream wall surface D22b to each other. The outer circumferential wall surface D22d is a wall surface facing the inner circumferential wall surface D22c (that is, closer to the first chamber D21), extends cylindrically along the central axis O, and connects outer circumferences of the downstream wall surface 22a and the upstream wall surface D22b to each other.

The plurality of fuel nozzles N2 are connected to the second chamber D22. The inlets N2a of all the fuel nozzles N2 are opened in the downstream wall surface D22a of the second chamber D22. The inlets N2a of the fuel nozzles N2 face the upstream wall surface D22b of the second chamber D22, and are misaligned with respect to the outlet P2c of the fuel supply flow passage P2 in the liner radial direction (to the inner circumferential side) as described above. Furthermore, a communication opening C2a is opened in the outer circumferential wall surface D22d of the second chamber D22, and this communication opening C2a faces the inner circumferential wall surface D22c of the second chamber D22. The communication opening C2a is an outlet of the communication flow passage C2 and in communication with the first chamber D21. The second chamber D22 is configured with a region D22x (FIG. 6) spreading from this communication opening C2a toward the combustion chamber 13 (downstream). The inlets N2a of the plurality of (all the) fuel nozzles N2 are thereby located closer to the combustion chamber 13 than entirety of the communication opening C2a. In the present embodiment, the second chamber D22 is formed to be thicker downstream along the central axis O than the first chamber D21. It is assumed that a dimension of the region D22x in a direction of extension of the central axis O is, for example, equal to or greater than an opening diameter of the communication opening C2a. Moreover, the fuel F2 flowing in the communication flow passage C2 is jetted inward in the liner radial direction (in a direction across a direction of a flow in the fuel nozzles N2) at a position apart from the inlet N2a of the closest fuel nozzle N2 (closest to the communication opening C2a) in the second chamber D22 by the region D22x.

### Communication Flow Passage C2

The communication flow passage C2 extends in the liner radial direction and communicates the first chamber D21 with the second chamber D22. An inlet of the communication flow passage C2 is opened in the inner circumferential wall surface D21c of the first chamber D21, and the outlet (communication opening C2a) thereof is opened in the outer circumferential wall surface D22d of the second chamber D22 to face the inner circumferential wall surface D22c as described above. In the present embodiment, a dimension of the communication flow passage C2 in a liner axial direction (along the central axis O) is set smaller than dimensions of the first chamber D21 and the second chamber D22 in the same direction. For example, a plurality of sets of communication openings C2a (outlets of the communication flow passage C2) are provided in the liner circumferential direction, and the first chamber D21 and the second chamber D22 communicate with each other in a plurality of circumferential portions. Alternatively, the header D2 can be configured in such a manner that the communication opening C2a and the communication flow passage C2 are each formed into a ring shape, and that the first chamber D21 and the second chamber D22 communicate with each other over entire circumferences.

### Fuel Header D3

Similarly to the fuel header D2, the fuel header D3 is configured with two hollow spaces, that is, a first chamber D31 and a second chamber D32, and a communication flow passage C3 communicating the first chamber D31 with the second chamber D32. The second chamber D32 of the fuel header D3 is disposed between the first chamber D31 of the fuel header D3 and the second chamber D22 of the fuel header D2, and located downstream of the first chamber D21 of the fuel header D2. The first chamber D31 and the second chamber D32 are nearly identical in a dimension in the liner axial direction. Configurations of the fuel header D3 are substantially similar to those of the fuel header D2 except for this respect. In the second chamber D32, a communication opening (outlet of the communication flow passage C3) is opened at a position apart downstream from inlets of the fuel nozzles N3. Furthermore, the second chamber D32 is configured with a region (corresponding to the region D22x of FIG. 6) spreading from the communication opening toward the combustion chamber 13 (downstream), and the inlets of the plurality of (all the) fuel nozzles N3 are located closer to the combustion chamber 13 than entirety of the communication opening.

### Operations

### F1 Burner

Upon opening the shut-off valve V11, the fuel F1 is supplied from the F1 fuel supply system to the F1 burner 20a, and an injection flow rate of the fuel F1 from the F1 burner 20a is controlled by control of an opening degree of the fuel control valve V12. The fuel F1 supplied from the F1 fuel supply system is delivered through the fuel supply flow passage P1, supplied to the fuel header D1, and distributed to the plurality of fuel nozzles N1. The fuel F1 jetted from each fuel nozzle N1 passes, together with the combustion air A4, through the corresponding air hole H1 and is jetted to the combustion chamber 13. At this time, the fuel F1 supplied to the fuel header D1 decelerates according to a gentle increase in a flow passage cross-sectional area of the fuel supply flow passage P1; thus, it is possible to suppress a deviation of flow rates of the fuel F1 flowing in the fuel nozzles N1 without dividing the fuel header D1 into two chambers.

### F2 Burner

Upon opening the shut-off valve V21, the fuel F2 is supplied from the F2 fuel supply system to the F2 burner 20b, and an injection flow rate of the fuel F2 from the F2 burner 20b is controlled by control of an opening degree of the fuel control valve V22. The fuel F2 supplied from the F2 fuel supply system is delivered through the fuel supply flow passage P2, and supplied to the first chamber D21 of the fuel header D1. The fuel F2 jetted from the second fuel supply flow passage P2 to the first chamber D21 collides against the opposed downstream wall surface D21a to reduce a dynamic pressure of the fuel F2, the first chamber D21 is filled with the fuel F2, and the fuel F2 flows in the second chamber D22 through the communication flow passage C2. The fuel F2 jetted from the communication flow passage C2 collides against the inner circumferential wall surface D22c of the second chamber D22 at the position apart from the inlets N2a of the fuel nozzles N2 by the region D22x, and the second chamber D22 is filled with the fuel F2. The fuel F2 with which the second chamber D22 is filled in this way is distributed to the fuel nozzles N2. The fuel F2 jetted from each fuel nozzle N2 passes, together with the combustion air A4, through the corresponding air hole H2 and is jetted to the combustion chamber 13.

### F3 Burner

The F3 burner 20c operates similarly to the F2 burner 20b. In other words, upon opening the shut-off valve V31, the fuel F3 is supplied from the F3 fuel supply system to the F3 burner 20c, and an injection flow rate of the fuel F3 from the F3 burner 20c is controlled by control of an opening degree of the fuel control valve V32. The fuel F3 jetted to the first chamber D31 collides against the opposed downstream wall surface (corresponding to the downstream wall surface D21a of the first chamber D21) to reduce a dynamic pressure of the fuel F3, and flows in the second chamber D32 through the communication flow passage C3. The fuel F3 jetted from the communication flow passage C3 collides against the inner circumferential wall surface at a position apart from the inlets of the fuel nozzles N3 by a distance (corresponding to the region D22x), the second chamber D32 is filled with the fuel F3, and the fuel F3 is distributed to the fuel nozzles N3. The fuel F3 jetted from each fuel nozzle N3 passes, together with the combustion air A4, through the corresponding air hole H3, and is jetted to the combustion chamber 13.

### Advantages

Since the F2 burner 20b surrounding the central F1 burner 20a is formed into the ring shape, the fuel header D2 of the F2 burner 20b is also ring-shaped. On the other hand, since the fuel supply flow passage P2 is a long and thin hole that has the circular cross-section, the fuel supply flow passage P2 is connected to one circumferential portion of the ring-shaped fuel header D2. If the fuel header D2 is one doughnut-shaped chamber without division into the two chambers, a deviation of flow rates of the fuel F2 flowing in the fuel nozzles N2 is possibly generated depending on distances to the outlet P2c of the fuel supply flow passage P2.

In the present embodiment, by contrast, the fuel header D2 is divided into the two chambers, that is, the first chamber D21 and the second chamber D22, and the first chamber D21 temporarily receives the fuel F2 supplied from the fuel supply flow passage P2. The outlet P2c of the fuel supply flow passage P2 is misaligned with respect to the inlets N2a of all the fuel nozzles N2, and the fuel F2 guided into the first chamber D21 collides against the downstream wall surface D21a of the first chamber D21 to reduce the dynamic pressure and turns. Owing to this, the subsequent deviation of flow rates can be suppressed for amounts of the fuel flowing in the fuel nozzles N2 and eventually amounts of the fuel injected from the fuel nozzles N2.

Furthermore, at a time of jetting the fuel F2 to the second chamber D22 of the fuel header D2, the fuel F2 jetted from the communication flow passage C2 passes across the inlet N2a of the closest fuel nozzle N2 if the communication opening C2a is provided in a downstream end portion of the outer circumferential wall surface D22d of the second chamber D22. In other words, the fuel F2 jetted from the communication flow passage C2 is a shear flow, as opposed to a flow of the fuel F2 flowing in the fuel nozzles N2. In this case, even if the dynamic pressure of the fuel F2 is reduced in the first chamber D21, then a static pressure difference affects an inflow operation of the fuel F2 to the fuel nozzles N2 depending on a jet speed of the fuel F2 to the second chamber D22, and a deviation tends to be generated in fuel injection flow rates of the fuel nozzles N2.

In the present embodiment, by contrast, the fuel F2 is apart from the inlets N2a of the fuel nozzles N2 by the region D22x in the second chamber D22. Owing to this, it is difficult for the static pressure difference caused by the jet speed of the fuel F2 to affect the inflow operation of the fuel F2 to the fuel nozzles N2, and the deviation of the fuel injection flow rates among the fuel nozzles N2 is suppressed.

As described so far, it is possible to suppress the deviation of fuel injection amounts among the plurality of fuel nozzles N2 connected to the same fuel header D2 and suppress increases in a manufacturing man-hour count and a pressure loss of the fuel even without providing an orifice on each fuel nozzle N2. A similar principle applies to the F3 burner 20c, and it is possible to suppress the deviation of fuel injection amounts among the fuel nozzles N3 while suppressing increases in the manufacturing man-hour count and the pressure loss of the fuel. Moreover, in the F1 burner 20a, the deviation of fuel injection amounts among the fuel nozzles N1 is small, as described above. Furthermore, since the deviations of fuel injection amounts among the fuel nozzles can be suppressed in the F1 burner 20a, the F2 burner 20b, and the F3 burner 20c, it is possible to achieve a NOx emissions reduction of the gas turbine 1. Moreover, it is possible to dispense with a compressor for fuel pressure rising or reduce pressure rising power.

### Second Embodiment

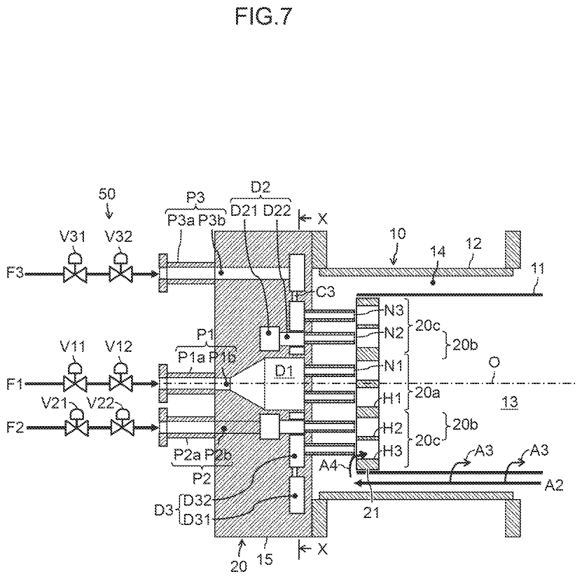

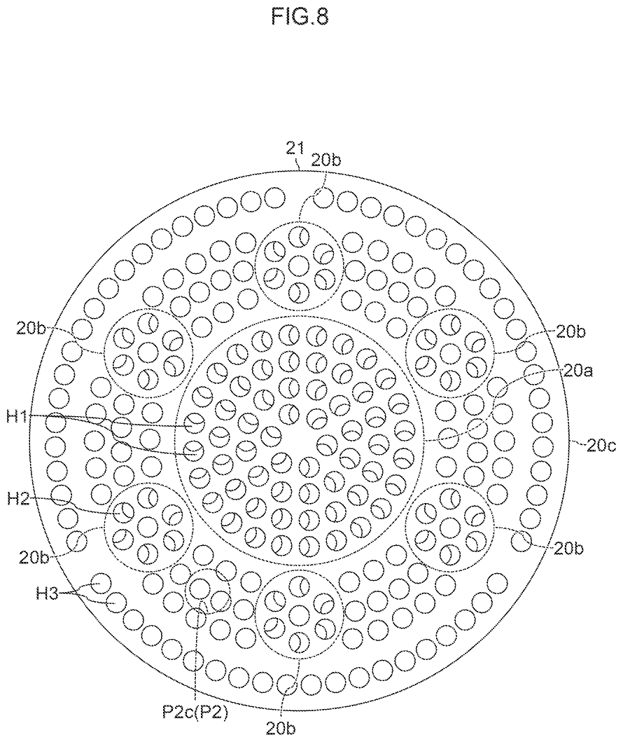

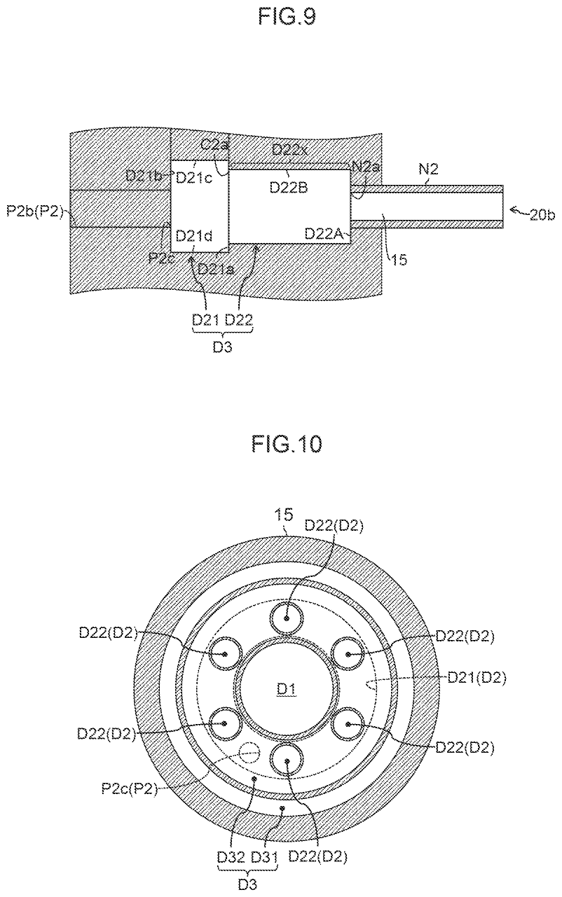

FIG. 7 is a cross-sectional view of a combustor according to a second embodiment of the present invention, and FIG. 8 depicts an air hole plate according to the present embodiment viewed from the combustion chamber side. FIG. 9 is a partial cross-sectional view of enlarged configurations of a fuel header provided in the combustor according to the present embodiment, and FIG. 10 is a perspective cross-sectional view of an end cover taken along a line X-X of FIG. 7. Similar or corresponding elements to those according to the first embodiment are denoted by the same reference characters as those depicted in FIGS. 1 and 3 in FIGS. 7 to 10, and description thereof will be omitted. The combustor according to the present embodiment differs from the combustor according to the first embodiment in configurations of the F2 burner 20b. Second chambers D22 of the fuel header D2 of the F2 burner 20b, the fuel nozzles N2, and the air holes H2 are disposed to be distributed in a plurality of circumferential portions (six portions in the present example), and the first chamber D21 and the second chamber D22 of the fuel header D2 are disposed side by side in the direction of extension of the central axis O.

In the present embodiment, configurations of the F1 burner 20a are identical to those according to the first embodiment. While configurations of the F3 burner 20c are generally similar to those according to the first embodiment, the F2 burner 20b does not lie between the F3 burner 20c and the F1 burner 20a. The air holes H3 configuring the F3 burner 20c form at least one annular air hole row (four rows in the present embodiment) surrounding the F1 burner 20a (FIG. 8), and the fuel nozzles N3 are disposed so as to correspond to the air holes H3. The fuel nozzles N3 are connected to the second chamber D32 of the fuel header D3, similarly to the first embodiment.

On the other hand, the air holes H2 configuring the F2 burner 20b are present so as to cut in on installation areas of the air holes H3 of the F3 burner 20c in the air hole plate 21 and form a plurality of (six in the present example) air hole groups at equidistant intervals in the circumferential direction. In each group, each of a plurality of air holes H2 has the rotation angle (FIG. 4) similarly to the air holes H1 of the F1 burner 20a. A plurality of groups (six groups in the present example) of fuel nozzles N2 are provided so as to correspond to the air holes H2, and each fuel nozzle N2 is installed with the injection hole oriented toward the corresponding air hole H2.

The fuel header D2 has the first chamber D21 and the second chamber D22 similarly to the first embodiment. However, while having one first chamber D21, the fuel header D2 has a plurality of (six in the present example) second chambers D22 in the present embodiment. Each second chamber D22 is connected to the first chamber D21 via the communication opening C2a without via the communication flow passage.

The first chamber D21 according to the present embodiment has similar configurations to those according to the first embodiment, and is formed into the ring shape by the downstream wall surface D21a, the upstream wall surface D21b, the inner circumferential wall surface D21c, and the outer circumferential wall surface D21d. The fuel supply flow passage P2 (communication flow passage P2b) is connected to the first chamber D21. The outlet P2c of the fuel supply flow passage P2 is opened in the upstream wall surface D21b of the first chamber D21. The outlet P2c of the fuel supply flow passage P2 is completely misaligned with respect to any of the second chambers D22 in the circumferential direction, and faces the inner wall surface of the first chamber D21 (downstream wall surface 21a between the two adjacent second chambers D22). The outlet P2c of the fuel supply flow passage P2 is thereby misaligned with respect to all of the second chambers D22 and eventually the inlets N2a of all of the plurality of fuel nozzles N2 opened in each second chamber D22 in the liner circumferential direction (FIG. 10).

On the other hand, each second chamber D22 of the fuel header D2 is formed as a columnar space defined by a downstream wall surface (second downstream wall surface) D22A and an inner circumferential surface D22B. The downstream wall surface D22A is a circular plane surface facing the opposite side to the combustion chamber 13. The inner circumferential surface D22B is a cylindrical circumferential surface extending downstream from an outer edge of the downstream wall surface D22A. In each second chamber D22, an end portion facing the downstream wall surface D22A, that is, an upstream end portion is entirely opened as the communication opening C2a with the first chamber D21. In each second chamber D22, a plurality of fuel nozzles N2 (only one fuel nozzle N2 is depicted in FIG. 9) are connected to the downstream wall surface D22A. A plurality of second chambers D22 configured in this way are disposed annularly, and connected to the downstream wall surface D21a of the same first chamber D21 via the communication openings C2a. While each communication opening C2a faces the inlets N2a of the fuel nozzles N2 in the present embodiment, the second chamber D22 having a larger diameter than that of the inlets N2a lies between the communication opening C2a and the inlets N2a. In the present embodiment, an entire length of each second chamber D22 in the direction of extension of the central axis O corresponds to the region D22x described above. It is assumed that the dimension of the region D22x in the direction of extension of the central axis O is, for example, equal to or greater than the opening diameter of each communication opening C2a (that is, the second chamber D22 extends along the central axis O).

Other configurations are similar to those according to the first embodiment.

In the present embodiment, the F1 burner 20a and the F3 burner 20c operate similarly to those according to the first embodiment. As for each F2 burner 20b, upon opening the shut-off valve V21, the fuel F2 is supplied from the F2 fuel supply system to the F2 burner 20b, and the injection flow rate of the fuel F2 from the F2 burner 20b is controlled by control of the opening degree of the fuel control valve V22, similarly to the first embodiment. The fuel F2 supplied from the F2 fuel supply system is delivered through the fuel supply flow passage P2, and supplied to the first chamber D2l of the fuel header D1. The fuel F2 jetted from the fuel supply flow passage P2 to the first chamber D2l collides against the opposed downstream wall surface D21a to reduce the dynamic pressure of the fuel F2, the ring-shaped first chamber D2l is filled with the fuel F2, and the fuel F2 is distributed to flow in the plurality of second chambers D22 via the communication openings C2a. In each second chamber D22, the region D22x is filled with the fuel F2 flowing from the communication opening C2a, and the fuel F2 is distributed to the fuel nozzles N2 from the inlets N2a apart by the region D22x. Furthermore, the fuel F2 jetted from each fuel nozzle N2 passes, together with the combustion air A4, through the corresponding air hole H2 and jetted to the combustion chamber 13. In the present embodiment, each air hole H2 configuring each F2 burner 20b has the rotation angle; thus, the fuel F2 jetted from the F2 burner 20b forms a circulating flow by the rotation and stabilizes a flame, similarly to the fuel F1 jetted from the F1 burner 20a. The heat of combustion of each F2 burner 20b can further stabilize the flame by the F3 burner 20c, and improve combustion stability at a time of a partial load at which the injection amount of the fuel F2 does not reach a fixed amount.

While the fuel F2 flows in each second chamber D22 in a fuel injection direction by each of the fuel nozzles N2 in the fuel header D2 according to the present embodiment, the inlet N2a of each fuel nozzle N2 is apart from the communication opening C2a by the region D22x within the second chamber D22. Owing to this, it is difficult for the static pressure difference due to a speed of the fuel F2 flowing from the first chamber D21 in each second chamber D22 to affect the inflow operation of the fuel F2 to the fuel nozzles N2. Thus, the present embodiment can obtain similar advantages to those of the first embodiment.

### Third Embodiment

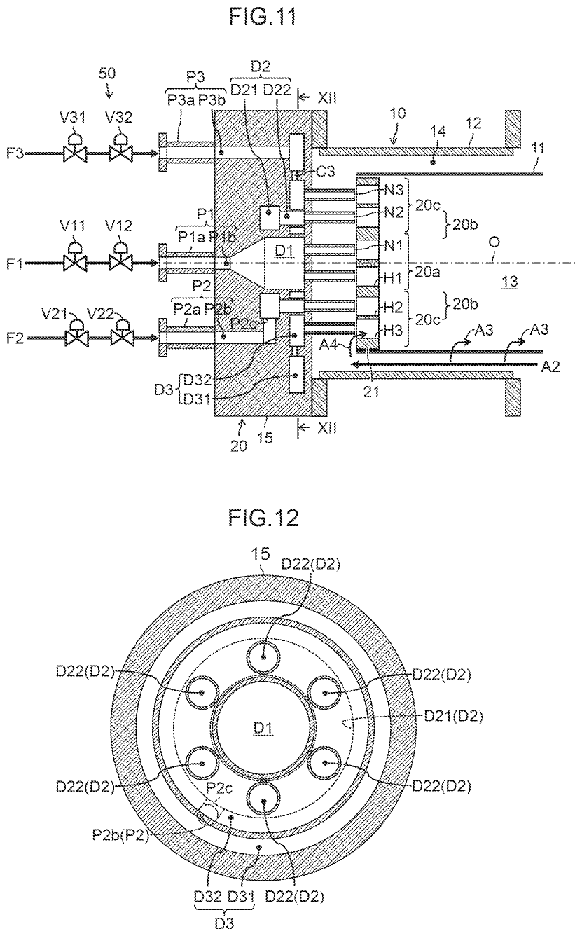

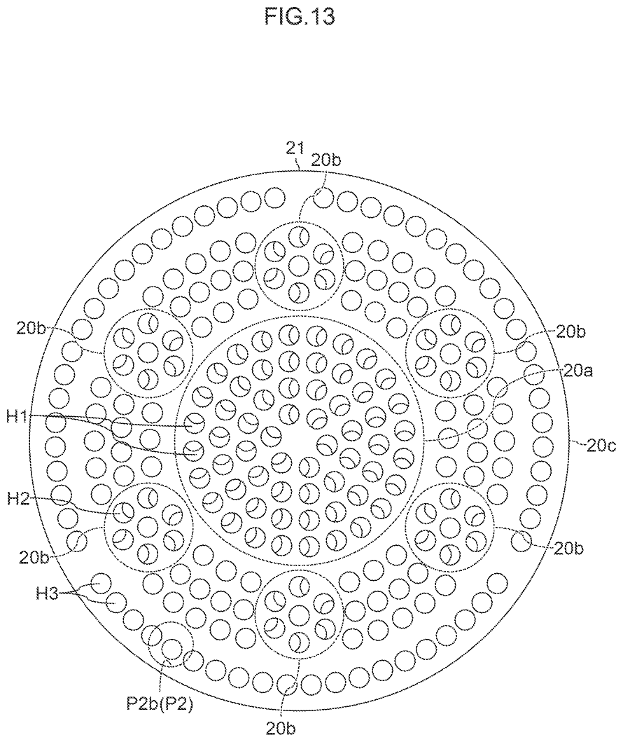

FIG. 11 is a cross-sectional view of a combustor according to a third embodiment of the present invention, FIG. 12 is a perspective cross-sectional view of an end cover taken along a line XII-XII of FIG. 11, and FIG. 13 depicts an air hole plate according to the present invention viewed from the combustion chamber side. FIGS. 11 to 13 correspond to FIGS. 7, 10, and 8 according to the second embodiment, respectively, elements similar or corresponding to those according to the second embodiment are denoted by the same reference characters as those depicted in FIGS. 7, 10, and 8 in FIGS. 11 to 13, and description thereof will be omitted. The combustor according to the present embodiment differs from the combustor according to the second embodiment in that the outlet P2c of the fuel supply flow passage P2 is misaligned with respect to all of a plurality of second chambers D22 of the fuel header D2 in the liner radial direction in the F2 burners 20b. In the present embodiment, a downstream end of the fuel supply flow passage P2 (communication flow passage P2b) is bent inward in the liner radial direction. The outlet P2c of the fuel supply flow passage P2 is opened in the outer circumferential wall surface D22d (refer to FIG. 6) of the fuel header D2 and faces the inner circumferential wall surface D21c (refer to FIG. 6) that is the inner wall surface of the first chamber D21. Furthermore, in the present embodiment, the outlet P2c of the fuel supply flow passage P2 is misaligned with respect to all the second chambers D22 in the liner circumferential direction (FIG. 12).

The present embodiment is similar to the second embodiment in the other configurations.

In the present embodiment, the outlet P2c of the fuel supply flow passage P2 is similarly misaligned with respect to the inlets N2a of all the fuel nozzles N2; thus, the fuel F2 guided into the first chamber D21 collides against the inner circumferential wall surface D21c of the first chamber D21 to reduce the dynamic pressure. Owing to this, the present embodiment can obtain similar advantages to those of the second embodiment. Particularly in the present embodiment, an effect to suppress the deviation of flow rates is high since the outlet P2c of the fuel supply flow passage P2 is misaligned with respect to all the second chambers D22 in both the circumferential direction and the radial direction.

### Fourth Embodiment

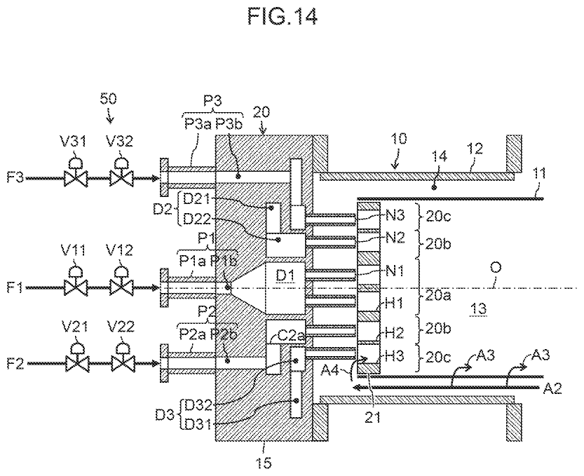

FIG. 14 is a cross-sectional view of a combustor according to a fourth embodiment of the present invention. FIG. 14 corresponds to a combustor part depicted in FIG. 1 according to the first embodiment, similar or corresponding elements to those according to the first embodiment are denoted by the same reference characters as those in FIG. 1 in FIG. 14, and description thereof will be omitted. The combustor according to the present embodiment differs from the combustor according to the first embodiment in that the communication flow passage C2 is not provided in the fuel header D2 and the first chamber D21 directly communicates with the second chamber D22. In other words, inner wall surfaces of both the first chamber D21 and the second chamber D22 are opened in a way of sharing the communication opening C2a therebetween. The fuel header D3 is similarly configured.

The present embodiment is similar to the first embodiment in the other configurations. Even with such configurations, the present embodiment can obtain similar advantages to those of the first embodiment by ensuring the distance along the central axis O (region D22x described with reference to FIG. 6) between the inlets N2a of the fuel nozzles N2 and the communication opening C2a in the second chamber D22 similarly to the first embodiment. The same thing is true for the fuel header D3.

### Modification

While it is not always necessary to provide orifices in the fuel nozzles N1 to N3 to make uniform the fuel flow rates of many fuel nozzles present in the embodiments described so far, it is allowed to install orifices in part of or all of the fuel nozzles N1 to N3 as needed.

Furthermore, the configuration, for example, such that the first chamber D21 of the fuel header D2 surrounds the outer circumference of the second chamber D22 has been exemplarily described in the first embodiment. However, the fuel header D2 may be configured in such a manner that the first chamber D21 is disposed, for example, on the inner circumferential side of the second chambers D22 if it is necessary to change a position relationship due to a relationship with the other constituent elements. The same thing is true for the fuel header D2 and the other embodiments.

While the combustor configured with the three burners, that is, the F1 burner 20a, the F2 burner 20b, and the F3 burner 20c has been exemplarily described, the present invention is also applicable to a combustor with the number of burners equal to or smaller than two or equal to or greater than four.

What is claimed is:

1. A gas turbine combustor comprising:
a cylindrical liner with a combustion chamber inside;
a plurality of fuel nozzles each disposed with an injection hole oriented toward the combustion chamber;
a fuel header to which the plurality of fuel nozzles are connected; and
a fuel supply flow passage connected to the fuel header, wherein
the fuel header includes a first chamber to which the fuel supply flow passage is connected, and a second chamber to which the plurality of fuel nozzles are connected,
an outlet of the fuel supply flow passage is opened in the first chamber,
at least one communication opening communicating with the first chamber is opened in the second chamber,
the outlet of the fuel supply flow passage faces an inner wall surface of the first chamber,
the second chamber includes a region spreading from the communication opening toward the combustion chamber, and
inlets of the plurality of fuel nozzles are located closer to the combustion chamber than entirety of the communication opening.

2. The gas turbine combustor according to claim 1, further comprising:
an air hole plate disposed on one axial side of the liner and facing the combustion chamber, wherein
a plurality of air holes are provided in the air hole plate to penetrate through the air hole plate, and
the plurality of fuel nozzles are disposed each with the injection hole oriented toward corresponding one of the air holes or each with a tip end inserted into corresponding one of the air holes.

3. The gas turbine combustor according to claim 1, wherein
the outlet of the fuel supply flow passage opened in the first chamber is misaligned with respect to inlets of all of the fuel nozzles opened in the second chamber in a radial direction or a circumferential direction of the liner.

4. The gas turbine combustor according to claim 1, wherein
the first chamber is formed into a ring shape by a ring-shaped first downstream wall surface facing an opposite side to the combustion chamber, a ring-shaped first upstream wall surface facing the first downstream wall surface, a first inner circumferential wall surface, and a first outer circumferential wall surface,
the second chamber is formed into a ring shape by a ring-shaped second downstream wall surface facing the opposite side to the combustion chamber, a ring-shaped second upstream wall surface facing the second downstream wall surface, a second inner circumferential wall surface, and a second outer circumferential wall surface,
the first chamber is disposed to surround an outer side of the second chamber in the radial direction of the liner,
the outlet of the fuel supply flow passage is opened in the first upstream wall surface and faces the first downstream wall surface, and
the communication opening is opened in the second outer circumferential wall surface and faces the second inner circumferential wall surface.

5. The gas turbine combustor according to claim 4, further comprising:
a communication flow passage that extends in the radial direction of the liner, that communicates the first chamber with the second chamber, and that has the communication opening as an outlet, wherein
a dimension of the communication flow passage in an axial direction of the liner is smaller than dimensions of the first chamber and the second chamber in the axial direction of the liner.

6. The gas turbine combustor according to claim 5, wherein
a plurality of sets of the communication openings and a plurality of sets of communication flow passages are provided in the circumferential direction of the liner, and the first chamber and the second chamber communicate with each other in a plurality of circumferential portions.

7. The gas turbine combustor according to claim 5, wherein
the communication opening and the communication flow passage are each formed into a ring shape, and the first chamber and the second chamber communicate with each other over entire circumferences.

8. The gas turbine combustor according to claim 1, wherein
the first chamber is formed into a ring shape by a ring-shaped first downstream wall surface facing an opposite side to the combustion chamber, a ring-shaped first upstream wall surface facing the first downstream wall surface, an inner circumferential wall surface, and an outer circumferential wall surface,
the second chamber is formed as a columnar space having a second downstream wall surface facing an opposite side to the combustion chamber, and an end portion facing the second downstream wall surface is opened as the communication opening,
a plurality of the second chambers are disposed annularly and connected to the first downstream wall surface of the first chamber via the communication openings, and
the outlet of the fuel supply flow passage is misaligned with respect to all of the plurality of second chambers in a circumferential direction or a radial direction of the liner, and faces the inner wall surface of the first chamber.
